(19) United States
(12) Patent Application Publication
(10) Pub. No.: US 2019/0267183 A1
(43) Pub. Date: Aug. 29, 2019

(54) INDUCTOR

(71) Applicant: NTN CORPORATION, Osaka (JP)

(72) Inventors: Kayo SAKAI, Kuwana (JP); Eiichirou Shimazu, Kuwana (JP); Shougo Kanbe, Kuwana (JP); Shinji Miyazaki, Kanie (JP)

(73) Assignee: NTN CORPORATION, Osaka (JP)

(21) Appl. No.: 16/404,314

(22) Filed: May 6, 2019

Related U.S. Application Data
(63) Continuation of application No. PCT/JP2017/040140, filed on Nov. 7, 2017.

(30) Foreign Application Priority Data
Nov. 9, 2016 (JP) 2016-218782
Sep. 4, 2017 (JP) 2017-169114

(51) Int. Cl. H01F 27/32; H01F 17/06; H01F 27/06

(52) U.S. Cl. CPC H01F 27/325; H01F 37/00; H01F 27/06; H01F 17/06

(57) ABSTRACT

Provided is a compact inductor in which electric insulation between a coil and a core is ensured. The inductor includes a core, a bobbin, and a coil. The core has a middle portion extending in a direction, and two collar portions spreading radially outward from both respective ends of the portion in the direction. The bobbin has a cylindrical portion extending in the direction and fitted to an outer periphery of the portion. The coil is wound on the portion via the portion. The bobbin further includes flange portions extending from both respective ends of the portion, each portion separating the corresponding portion from the coil, and a positioning portion located at a radially inner side with respect to a radially outer end of the portion. The positioning portion faces the corresponding portion, and projects toward and abuts the corresponding portion.

### CROSS REFERENCE TO THE RELATED APPLICATION

This application is a continuation application, under 35 U.S.C. § 111(a), of international application No. PCT/JP2017/040140, filed Nov. 7, 2017, which claims Convention priority to Japanese patent application No. 2016-218782, filed Nov. 9, 2016, and Japanese patent application No. 2017-169114, filed Sep. 4, 2017, the entire disclosures of which are herein incorporated by reference as a part of this application.

### BACKGROUND OF THE INVENTION

### Field of the Invention

The present invention relates to an inductor for an AC adapter, an electrical device in an electric vehicle, and devices of various electrical facilities and the like.

### Description of Related Art

Patent Document 1 discloses a core of an inductor. Patent Document 2 discloses a coil of an inductor.

In an inductor with a pot core, in the case of winding a coil 4 on a core 2 via a bobbin 103 formed from an insulating material as shown in FIG. 35, the bobbin 103 (see FIG. 36) is required to ensure electric insulation between the coil 4 and the core 2. Electric insulation is determined by the spatial distance (clearance) and the creepage distance between two conductive portions. In the case of the inductor 101 in which the entire size thereof is limited and thus a large spatial distance is impossible, it is desired to ensure a creepage distance. In the case of FIG. 35, a creepage distance L corresponds to a thickness La of a flange portion 103b of the bobbin 103 in the direction of a central axis O (the axial direction). That is, L=La.

A first improvement measure for ensuring a creepage distance of the bobbin 103 is to increase the thickness of the flange portion 103b of the bobbin 103 in the axial direction as shown in FIG. 37 and FIG. 38. In this case, the creepage distance L of the bobbin 103 corresponds to a thickness Laa of the flange portion 103b in the axial direction (Laa>La). That is, L=Laa.

A second improvement measure is to increase the diameter of the flange portion 103b of the bobbin 103 in such a way that the radially outer end of the flange portion 103b projects further than the radially outer end of the coil 4 as shown in FIG. 39 and FIG. 40. In other words, the coil 4 is wound such that a space is left at the radially inner side with respect to the radially outer end of the flange portion 103b of the bobbin 103. In this case, the creepage distance L of the bobbin 103 is the sum of a radial distance Ld between the radially outer end of the flange portion 103b and the radially outer end of the coil 4 to the thickness La of the flange portion 103b in the axial direction. That is, L=La+Ld.

### RELATED DOCUMENT

### Patent Document

[Patent Document 1] JP Patent No. 4763609

[Patent Document 2] JP Laid-Open Patent Publication No. 2000-331841

### SUMMARY OF THE INVENTION

However, when the thickness of the flange portion 103b of the bobbin 103 is increased as in the first improvement measure (FIG. 37), the size of the inductor 101 is increased in the axial direction. Likewise, when the diameter of the flange portion 103b of the bobbin 103 is increased as in the second improvement measure (FIG. 39), the size of the inductor 101 is increased in the radial direction.

An object of the present invention is to provide an inductor that has a coil wound via a bobbin and that can achieve size reduction while ensuring electric insulation between the coil and a core.

An inductor of the present invention is an inductor including a core having a middle portion extending in an axial direction, two core flange portions spreading radially outward from both respective ends of the middle portion in the axial direction, and a side wall portion connecting radially outer ends of the two respective core flange portions; a bobbin including a cylindrical portion extending in the axial direction, the cylindrical portion being fitted to an outer periphery of the middle portion; and an annular coil wound on the middle portion of the core via the cylindrical portion of the bobbin, wherein the bobbin further includes bobbin flange portions extending from both respective ends of the cylindrical portion, each bobbin flange portion separating the corresponding core flange portion of the core from the coil, and a positioning portion located at a radially inner side with respect to a radially outer end of the bobbin flange portion, the positioning portion being provided on a surface, of at least one of the bobbin flange portions, that faces the corresponding core flange portion, the positioning portion projecting toward and abutting at a distal end thereof the corresponding core flange portion.

According to this configuration, since the positioning portion of the bobbin abuts the core flange portion of the core, the bobbin is positioned in the axial direction, so that the distance between the core and the coil is kept constant. In this way, electric insulation between the core and the coil is ensured, and magnetic characteristics such as an inductance value are stabilized.

The positioning portion may be provided on each of surfaces, of both of the bobbin flange portions, each of the surfaces facing the corresponding core flange portion.

The creepage distance formed on the bobbin between the coil and the core is the sum of the thickness of the bobbin flange portion of the bobbin in the axial direction, the radial distance from the radially outer end of the bobbin flange portion to the positioning portion, and the projection length of the positioning portion. As compared to a conventional basic configuration not having any positioning portion (see FIG. 35), assuming that the thickness of a bobbin flange portion in the axial direction is equal to the thickness of the bobbin flange portion in the axial direction in the configuration of the present invention, the creepage distance in the above configuration is longer by a length equal to (radial distance from radially outer end of bobbin flange portion to positioning portion)+(projection length of positioning portion). Any radial positions of the positioning portion can be chosen. Thus, choosing the radial distance from the radially outer end of the bobbin flange portion to the positioning portion appropriately provides an adequate creepage distance.

Achieving an adequate creepage distance by providing the positioning portion to the bobbin as described above prevents the size in the axial direction from increasing contrary to a conventional configuration in which the thickness of the flange portion is increased (see FIG. 37), and also prevents the size in the radial direction from increasing contrary to a conventional configuration in which the diameter of the flange portion is increased (see FIG. 39). In this way, size reduction can be achieved while electric insulation between the coil and the core is ensured.

The core may include two pot-shaped core segments adjacent to each other in the axial direction. Alternatively, the core may have a peripheral core including side wall portion and the two core flange portions, a part of the side wall portion in a circumferential direction being open so that the peripheral core has a cup shape, and a central core that is assembled into the peripheral core so that both ends of the central core are in contact with respective inner surfaces of the two core flange portions in the axial direction, the central core corresponding to the middle portion. The peripheral core and the central core may be formed from magnetic materials that are the same as each other, or may be formed from magnetic materials that are different from each other.

The positioning portion may include three or more projections located so as to be spaced apart from each other in a circumferential direction. Moreover, the three or more projections may be located, on a circumference of a circle concentric with the bobbin, so as to be spaced apart from each other. Furthermore, intervals between any adjacent projections of the three or more projections may be equal to each other. Alternatively, the positioning portion may have a ring shape concentric with the bobbin.

The positioning portion that has any of these configurations positions the bobbin in the axial direction to keep the distance between the core and the coil constant. In addition, choosing the radial position of the positioning portion appropriately provides an adequate creepage distance formed on the bobbin between the coil and the core. The positioning portion having a ring shape allows a larger area of contact of the positioning portion with the core flange portion of the core, which enables the strength of the flange portion to be increased.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a partially cutaway perspective view of an inductor according to a first embodiment of the present invention;

FIG. 2 is a sectional view of the inductor in FIG. 1;

FIG. 3 is a perspective view of a bobbin of the inductor in FIG. 1;

FIG. 4 is a partially enlarged view of FIG. 2;

FIG. 5 is a partially cutaway perspective view of an inductor according to a second embodiment of the present invention;

FIG. 6 is a sectional view of the inductor in FIG. 5;

FIG. 7 is a perspective view of a bobbin of the inductor in FIG. 5;

FIG. 8 is a partially enlarged view of FIG. 6;

FIG. 9 is a partially cutaway perspective view of an inductor according to a third embodiment of the present invention;

FIG. 10 is a sectional view of the inductor in FIG. 9;

FIG. 11 is a perspective view of a bobbin of the inductor in FIG. 9;

FIG. 12 is a partially enlarged view of FIG. 10;

FIG. 13 is diagrams showing a core segment in an inductor according to a fourth embodiment of the present invention, wherein a diagram (A) is a plan view of the core segment and a diagram (B) is a sectional view of the core segment taken along a line XIIIB-XIIIB in the diagram (A);

FIG. 14 is a sectional view of the inductor according to the fourth embodiment with the core segments, each shown in FIG. 13;

FIG. 15 is diagrams showing a core segment in an inductor according to a fifth embodiment of the present invention, wherein a diagram (A) is a plan view of the core segment and a diagram (B) is a sectional view of the core segment taken along a line XVB-XVB in the diagram (A);

FIG. 16 is a sectional view of the inductor according to the fifth embodiment with the core segments, each shown in FIG. 15;

FIG. 17 is diagrams showing a core segment in an inductor according to a sixth embodiment of the present invention, wherein a diagram (A) is a front view of the core segment and a diagram (B) is a side view of the core segment in the diagram (A);

FIG. 18 is a perspective view of a bobbin that is to be used in combination with the core segment in FIG. 17;

FIG. 19 is a perspective view of the inductor according to the sixth embodiment formed by combining the core segment shown in FIG. 17 and the bobbin shown in FIG. 18;

FIG. 20 is a sectional view of the inductor in FIG. 19;

FIG. 21 is diagrams showing a core segment in an inductor according to a seventh embodiment of the present invention, wherein a diagram (A) is a front view of the core segment and a diagram (B) is a side view of the core segment in the diagram (A);

FIG. 22 is a sectional view of the inductor according to the seventh embodiment with the core segments, each shown in FIG. 21;

FIG. 23 is diagrams showing a core segment in an inductor according to an eighth embodiment of the present invention, wherein a diagram (A) is a plan view of the core segment and a diagram (B) is a side view of the core segment in the diagram (A);

FIG. 24 is a sectional view of the inductor according to the eighth embodiment with the core segments, each in FIG. 23;

FIG. 25 is a perspective view of an inductor according to a ninth embodiment of the present invention, including a core flange division type core;

FIG. 26 is a perspective view of the inductor in FIG. 25 divided vertically along a plane passing through the central axis of the core;

FIG. 27 is a sectional view of the inductor in FIG. 25;

FIG. 28 is diagrams illustrating assembly of the inductor in FIG. 25, wherein the inductor is assembled in order of diagrams (A) to (C);

FIG. 29 is a perspective view of an inductor according to a tenth embodiment of the present invention, including a core flange division type core;

FIG. 30 is a perspective view of the inductor in FIG. 29 divided vertically along a plane passing through the central axis of the core;

FIG. 31 is a sectional view of the inductor in FIG. 29;

FIG. 32 is diagrams illustrating assembly of the inductor in FIG. 29, wherein the inductor is assembled in order of diagrams (A) to (C);

FIG. 33 is a perspective view of an inductor according to an eleventh embodiment of the present invention, including a core flange division type core, wherein the inductor is divided vertically along a plane passing through the central axis of the core;

FIG. 34 is a sectional view of the inductor in FIG. 33;

FIG. 35 is a sectional view of a conventional basic inductor;

FIG. 36 is a perspective view of a bobbin of the inductor in FIG. 35;

FIG. 37 is a perspective view of a conventional inductor obtained through a first improvement measure;

FIG. 38 is a perspective view of a bobbin of the inductor in FIG. 37;

FIG. 39 is a perspective view of a conventional inductor obtained through a second improvement measure; and

FIG. 40 is a perspective view of a bobbin of the inductor in FIG. 39.

### DESCRIPTION OF EMBODIMENTS

Embodiments of the present invention will be described with reference to the drawings.

### First Embodiment

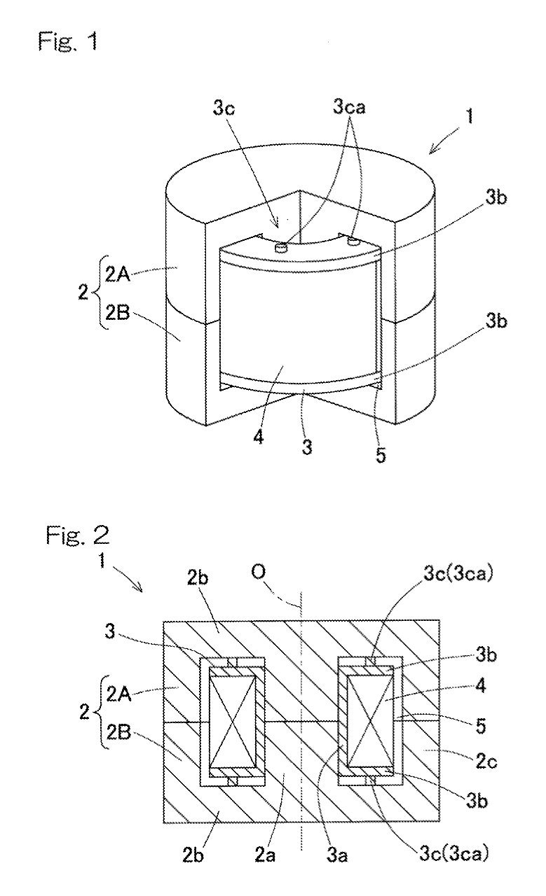

FIG. 1 is a partially cutaway perspective view of an inductor according to a first embodiment. FIG. 2 is a sectional view of the inductor. The inductor 1 includes a core 2 and an annular coil 4 wound on the core 2 via a bobbin 3.

As shown in FIG. 2, the core 2 includes a middle portion 2a, two collar portions (core flange portions) 2b, 2b that spread radially outward from both respective ends of the middle portion 2a in the direction of a central axis O (the axial direction), and a side wall portion 2c that connects the radially outer ends of the two respective collar portions 2b, 2b. An annular hollow portion 5 surrounded by the middle portion 2a, the collar portions 2b, 2b, and the side wall portion 2c is defined within the core 2. The bobbin 3 and the coil 4 are provided within the hollow portion 5. In this example, the middle portion 2a has a circular column shape, and the side wall portion 2c has a hollow cylindrical shape.

The core 2 of this embodiment is of an axial division type, in which the core 2 is formed of two separate core segments 2A and 2B, having respective adjacent division surfaces. The division surfaces are orthogonal to the central axis O. Each of the core segments 2A and 2B of this example is composed of a pot core having the same shape and having a longitudinal section with an E-shape. Both core segments 2A and 2B are magnetic bodies formed from the same magnetic material. The magnetic material is, for example, sinterable ferrite or the like. However, the magnetic material is not limited thereto.

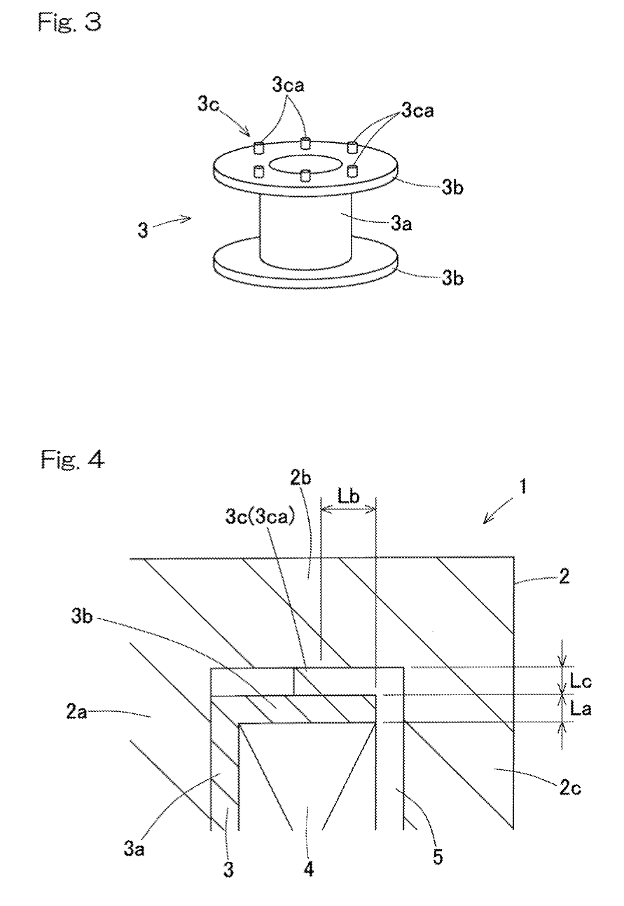

FIG. 3 is a perspective view of the bobbin. As shown in FIG. 3, the bobbin 3 has a hollow cylindrical portion 3a that is fitted to the outer periphery of the middle portion 2a (FIG. 2) of the core 2, and annular flange portions (bobbin flange portions) 3b, 3b that are located at both respective ends of the hollow cylindrical portion 3a in the axial direction. A later-described positioning portion 3c is provided on a surface, of each flange portion 3b, that faces the collar portion 2b (FIG. 2) of the core 2. The bobbin 3 is formed from an insulating material. The insulating material may be a resin material such as polyphenylene sulfide (PPS).

The coil 4 is obtained by winding a conductor wire (not shown) on the outer periphery of the hollow cylindrical portion 3a between the two flange portions 3b, 3b of the bobbin 3 as shown in FIG. 1 and FIG. 2. The conductor wire is wound to the radially outer end of each flange portion 3b. Both ends of the conductor wire are taken out of the core 2.

The conductor wire of the coil 4 may be a copper enameled wire. Specifically, the conductor wire may be a urethane wire (UEW), a formal wire (PVF), a polyester wire (PEW), a polyesterimide wire (EIW), a polyamideimide wire (AIW), a polyimide wire (PIW), a double covered wire which is a combination of these wires, a self-welding wire, a litz wire, or the like. The copper enameled wire may have round or square in cross section.

In a state where the bobbin 3 and the coil 4 are housed in the hollow portion 5 between the two core segments 2A and 2B, by adhering the division surfaces of the core segments 2A and 2B to each other, the inductor 1 is assembled. For adhering the division surfaces, for example, a solventless epoxy-based adhesive or silicone-based adhesive or the like is used in accordance with required heat resistance, etc. In the assembled state of the inductor 1, the core segments 2A and 2B, the bobbin 3, and the coil 4 are concentrically disposed.

The positioning portions 3c of the bobbin 3 will be described. The positioning portion 3c is provided on the surface, of each flange portion 3b, that faces the collar portion 2b of the core 2 and is located at the radially inner side with respect to the radially outer end of the flange portion 3b, and projects toward the collar portion 2b to be in contact with the collar portion 2b at a distal end thereof. As shown in FIG. 3, each of the positioning portions 3c of this embodiment includes three or more (for example, six) projections 3ca located so as to be spaced apart from each other in the circumferential direction. The intervals between any adjacent projections 3ca may be equal to each other. In the shown example, the respective projections 3ca are located on the circumference of a circle concentric with the bobbin 3, but do not have to be located on such a circumference.

In the assembled state of the inductor 1 shown in FIG. 1 and FIG. 2, since the distal ends of the positioning portions 3c are in contact with the collar portions 2b of the core 2, the bobbin 3 is positioned in the axial direction, so that the distance between the core 2 and the coil 4 is kept constant. In this way, electric insulation between the core 2 and the coil 4 is ensured, and magnetic characteristics such as an inductance value are stabilized.

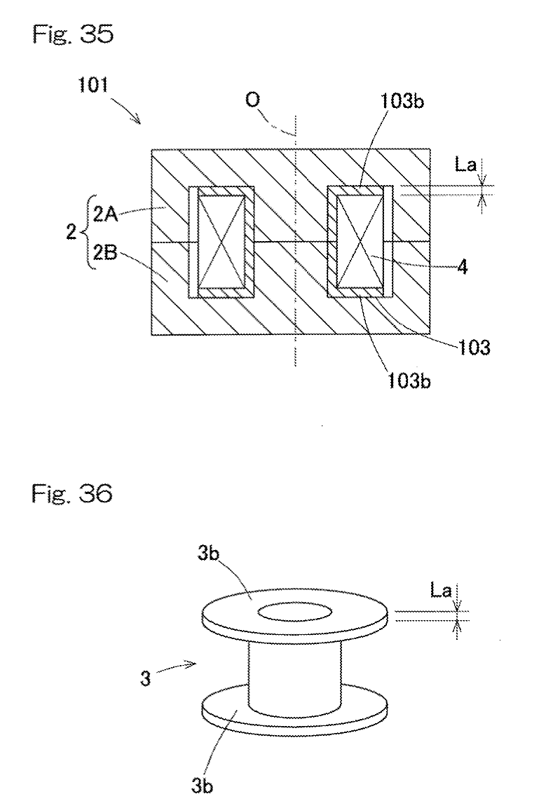

As shown in FIG. 4 which is a partially enlarged view of FIG. 2, a creepage distance L of the bobbin 3 is the sum of a thickness La of the flange portion 3b in the axial direction, a radial distance Lb from the radially outer end of the flange portion 3b to the positioning portion 3c, and a projection length Lc of the positioning portion 3c. That is, L=La+Lb+Lc. Meanwhile, in the case of a conventional basic configuration not having any positioning portions 3c (see FIG. 35), the creepage distance L of the bobbin 3 is equal to the thickness La of the flange portion 3b in the axial direction. When it is assumed that the thickness La of the flange portion 3b of this embodiment in the axial direction is equal to the thickness La of the flange portion 3b of the conventional basic configuration in the axial direction, the creepage distance L in the configuration of this embodiment is longer than that in the conventional basic configuration by a length equal to the sum of radial distance Lb and projection length Lc. Any radial positions of the positioning portions 3c can be chosen. Thus, choosing the radial distance Lb appropriately provides an adequate creepage distance L.

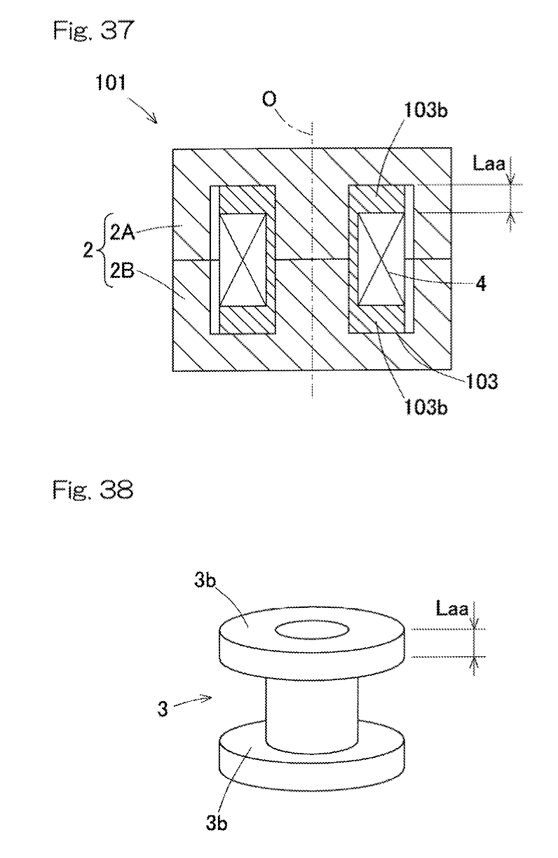

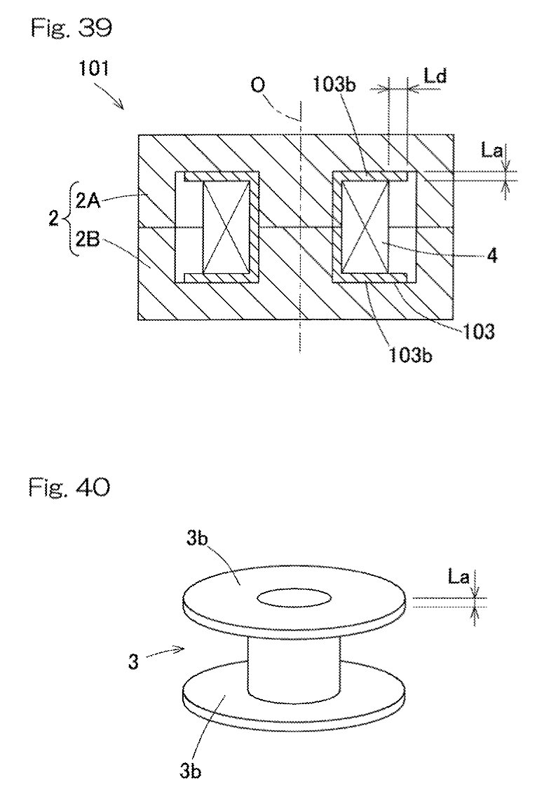

Achieving an adequate creepage distance L by providing the positioning portions 3c to the bobbin 3 as described above prevents the size in the axial direction from increasing contrary to the configuration in which the thickness of the flange portion 3b in the axial direction is increased (see FIG. 37), and also prevents the size in the radial direction from increasing contrary to the configuration in which the diameter of the flange portion 3b is increased (see FIG. 39). In this way, size reduction can be achieved while electric insulation between the coil 4 and the core 2 is ensured.

### Second Embodiment

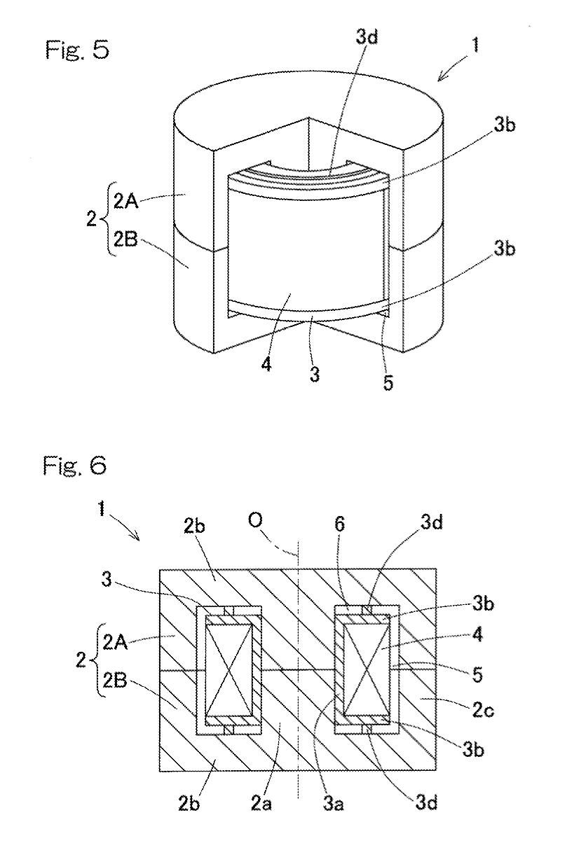

FIG. 5 to FIG. 8 show a second embodiment of the present invention. The second embodiment is different from the first embodiment in configuration of the positioning portions of the bobbin 3. The other configuration is the same as in the first embodiment. Components that are the same as those in the first embodiment are designated by the same reference numerals, and the description thereof is omitted.

The bobbin 3 of the inductor 1 has positioning portions 3d each having a ring shape concentric with the bobbin 3. In this case as well, the creepage distance L of the bobbin 3 is the sum of the thickness La of the flange portion 3b in the axial direction, a radial distance Lb from the radially outer end of the flange portion 3b to the positioning portion 3d, and a projection length Lc of the positioning portion 3d (FIG. 8). That is, L=La+Lb+Lc. Similar to the first embodiment, choosing the radial distance Lb appropriately provides an adequate creepage distance L.

Each positioning portion 3d having a ring shape enables the strength of each flange portion 3b to be increased. As such, the thickness of each flange portion 3b can be reduced. The positioning portions 3d define respective gaps 6 each is formed between the corresponding collar portion 2b of the core 2 and the corresponding flange portion 3b of the bobbin 3. When the radial dimension of the gap 6 is increased, the size of the ring-shaped positioning portion 3d is increased, so that the strength of the flange portion 3b is increased. As such, it is desirable to determine a radial position of each positioning portion 3d while ensuring an adequate creepage distance L.

### Third Embodiment

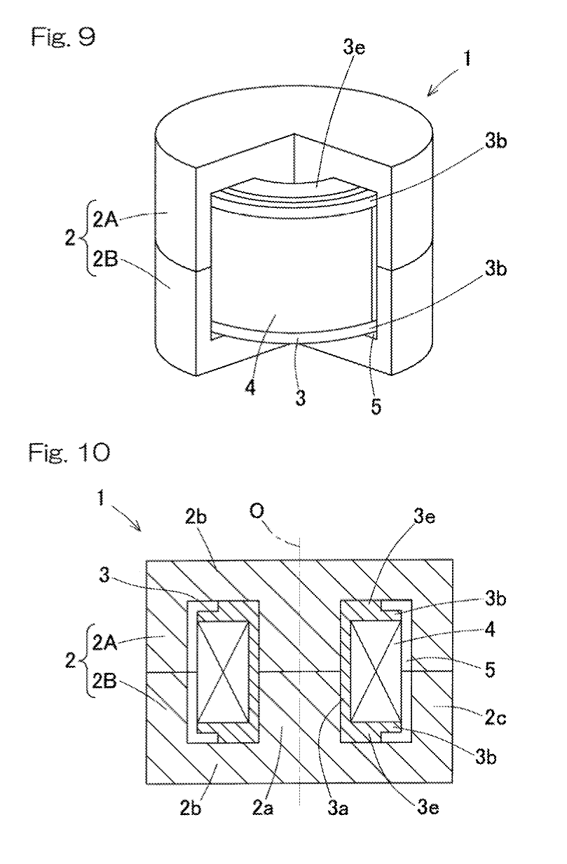

FIG. 9 to FIG. 12 show a third embodiment of the present invention. The third embodiment is different from the first embodiment and the second embodiment in configuration of the positioning portions of the bobbin 3. The other configuration is the same as in the first embodiment and the second embodiment. Components that are the same as those in the first embodiment and the second embodiment are designated by the same reference numerals, and the description thereof is omitted.

Similar to the bobbin 3 of the second embodiment, the bobbin 3 of the inductor 1 has positioning portions 3e each having a ring shape. Unlike the bobbin 3 of the second embodiment, the inner diameter of each positioning portion 3e is equal to the inner diameter of the bobbin 3. Similar to the second embodiment, the creepage distance L of the bobbin 3 is the sum of the thickness La of the flange portion 3b in the axial direction, a radial distance Lb from the radially outer end of the flange portion 3b to the positioning portion 3e, and a projection length Lc of the positioning portion 3e (FIG. 12). That is, L=La+Lb+Lc. Each ring-shaped positioning portion 3e having the inner diameter that is equal to the inner diameter of the bobbin 3 enables a large radial dimension of each positioning portion 3e. As such, the strength of each flange portion 3b can be further increased.

### Fourth Embodiment

An inductor according to a fourth embodiment includes an axial division type core 2. The configuration excluding the core 2 is the same as described in the first to third embodiments. Components that are the same as those in the first to third embodiments are designated by the same reference numerals, and the description thereof is omitted.

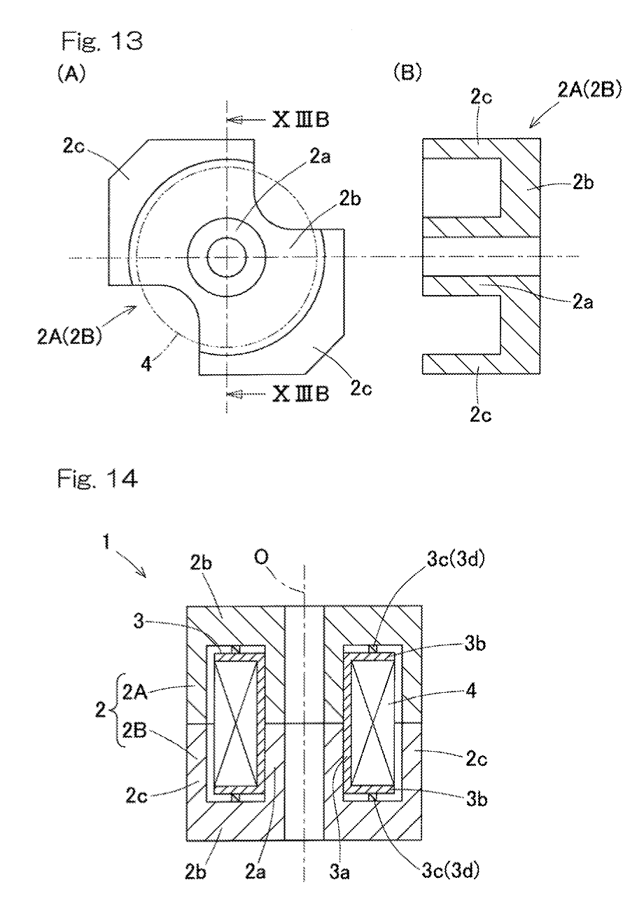

A diagram (A) in FIG. 13 is a plan view of an RM type core that is to be used as a core segment, and a diagram (B) in FIG. 13 is a sectional view of the RM type core taken along a line XIIIB-XIIIB To use the RM type core for the core of the inductor, two core segments each composed of the RM type core are combined to form a core, or one core segment composed of the RM type core and one core segment (not shown) composed of a flat-plate-shaped cover are combined to form a core. The same applies to other RM type cores described later.

FIG. 14 is a sectional view of an inductor 1 in which a core 2 is formed of two core segments 2A and 2B each composed of the RM type core. In the inductor 1 as well, the coil 4 is wound on the middle portion 2a of the core 2 via the bobbin 3. As shown by a broken line in the diagram (A) in FIG. 13, the coil 4 has a circular shape as seen in the direction of the central axis O (the axial direction).

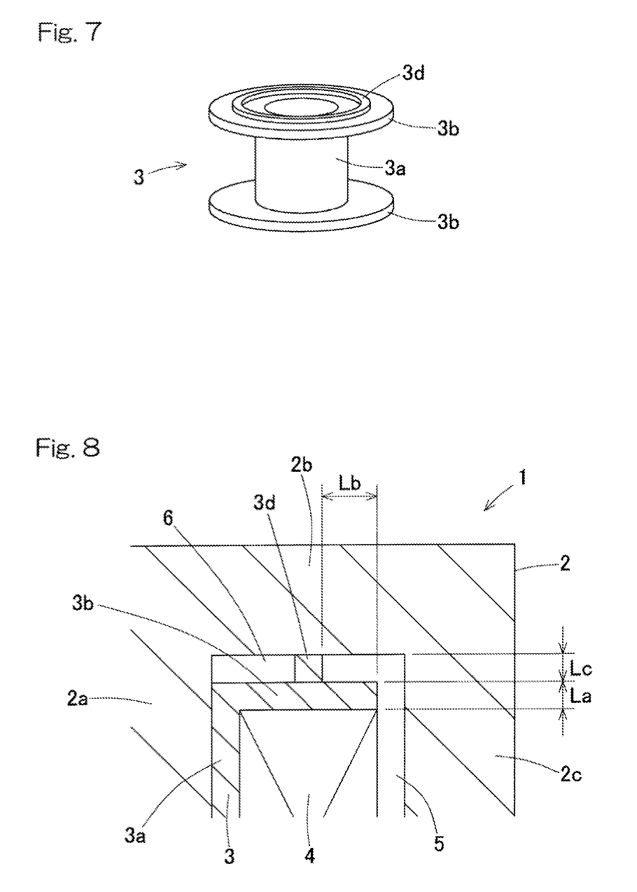

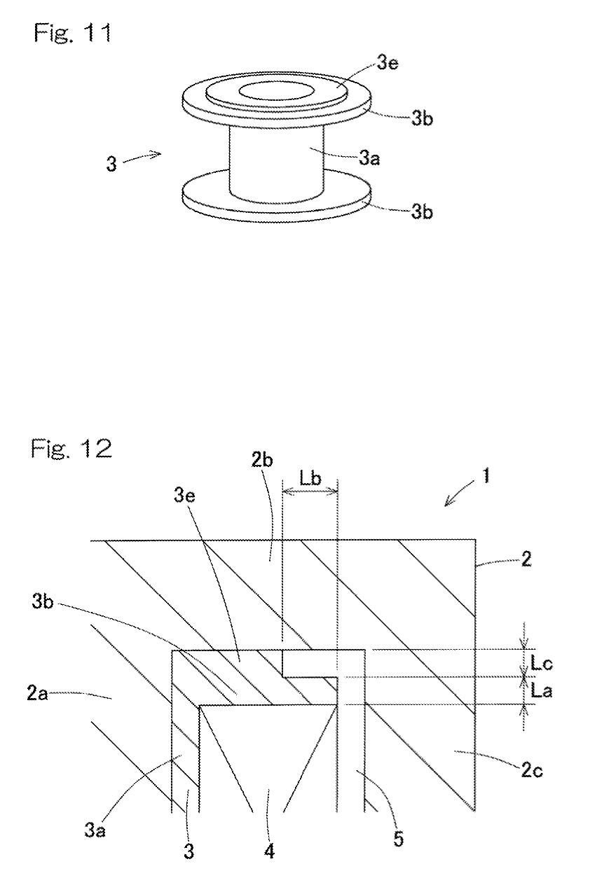

In FIG. 14, the bobbin 3 has substantially the same shape as the bobbin 3 of the first embodiment (FIG. 3) or the bobbin 3 of the second embodiment (FIG. 7). That is, the bobbin 3 has a hollow cylindrical portion 3a and flange portions 3b, 3b, and a positioning portion 3c (3d) is provided on a surface, of each flange portion 3b, that faces the collar portion 2b of the core 2. Using the bobbin 3 provided with the positioning portions 3c (3d) as described above provides an adequate creepage distance of the bobbin 3 between the coil 4 and the core 2 similar to the above. The bobbin 3 of the third embodiment (FIG. 11) may be used.

### Fifth Embodiment

An inductor according to a fifth embodiment also includes an axial division type core 2. The configuration excluding the core 2 is the same as described in the first to third embodiments. Components that are the same as those in the first to third embodiments are designated by the same reference numerals, and the description thereof is omitted.

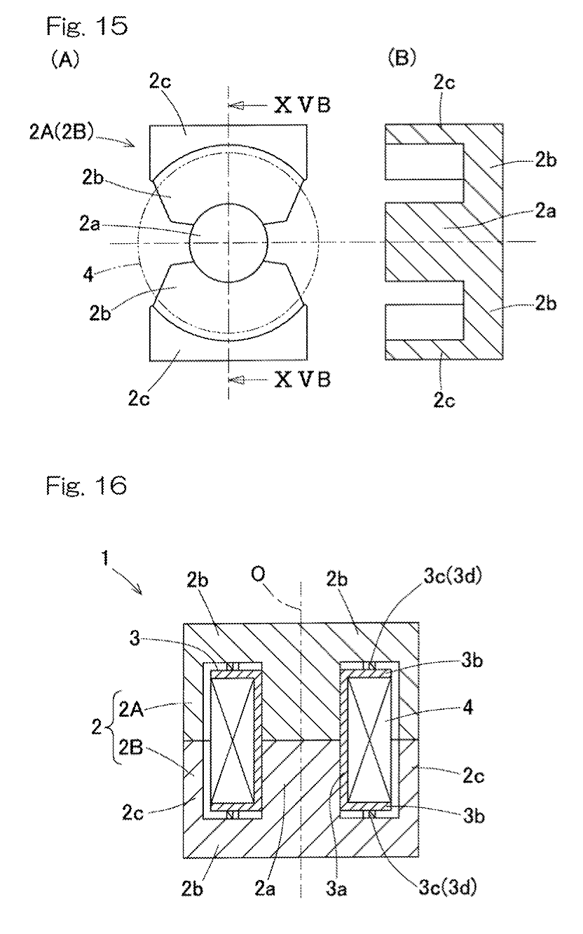

A diagram (A) in FIG. 15 is a plan view of a PQ type core, a diagram (B) in FIG. 15 is a sectional view of the PQ type core taken along a line XVB-XVB, and FIG. 16 is a sectional view of an inductor 1 in which a core 2 is formed of two core segments 2A and 2B each composed of the PQ type core. The bobbin 3 has substantially the same shape as the bobbin 3 of the first embodiment (FIG. 3) or the bobbin 3 of the second embodiment (FIG. 7). In the inductor 1 as well, using the bobbin 3 provided with the positioning portions 3c (3d) as described above provides an adequate creepage distance of the bobbin 3 between the coil 4 and the core 2. The bobbin 3 of the third embodiment (FIG. 11) may be used.

### Sixth Embodiment

An inductor according to a sixth embodiment includes a core 2 that is different from those of the inductors according to the preceding embodiments. Components that are the same as those in the preceding embodiments are designated by the same reference numerals, and the description thereof is omitted.

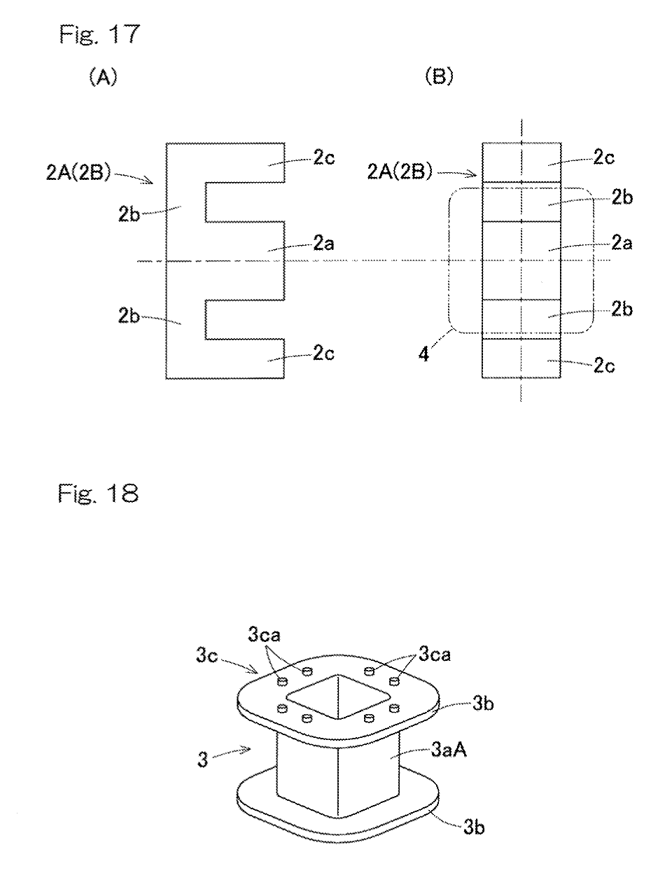

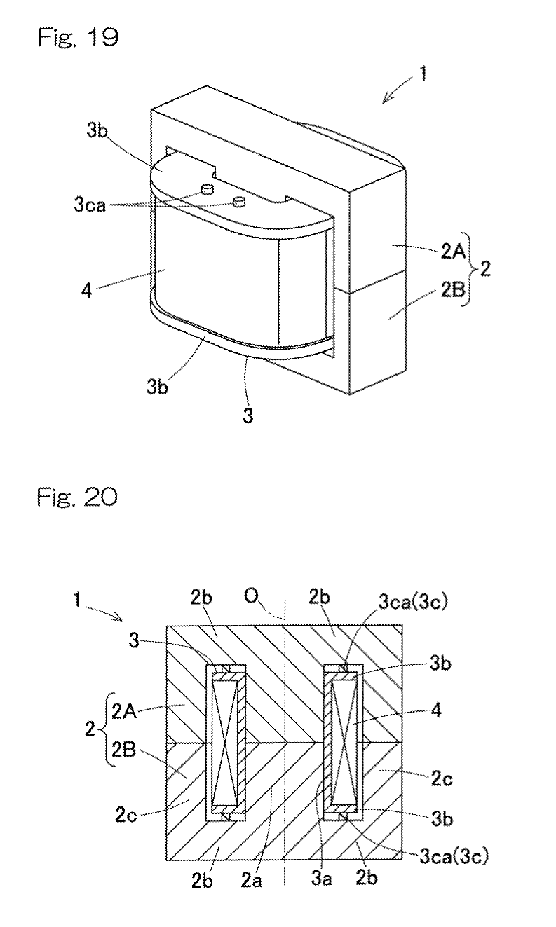

A diagram (A) in FIG. 17 is a front view of an E type core, a diagram (B) in FIG. 17 is a side view of the E type core, and FIG. 18 is a perspective view of a bobbin that is to be combined with the E type core. In addition, FIG. 19 is a perspective view of an inductor 1 formed of two core segments 2A and 2B each composed of the E type core shown in FIG. 17 and the bobbin 3 shown in FIG. 18. FIG. 20 is a sectional view of the inductor 1. Using the E type core in FIG. 17 as each of the core segments 2A and 2B causes the middle portion 2a of the core 2 to have a square column shape. As shown by a broken line in the diagram (B) in FIG. 17, the coil 4 has a square shape as seen in the direction of the central axis O (the axial direction).

As shown in FIG. 18, the bobbin 3 has: a square tube portion 3aA to be fitted to the outer periphery of the square-column-shaped middle portion 2a (the diagrams (A) and (B) in FIG. 17) of the core 2; and flange portions 3b, 3b extending from both respective ends of the square tube portion 3aA in the axial direction and have square shapes, and a positioning portion 3c is provided on a surface, of each flange portion 3b, that faces the collar portion 2b of the core 2. In the bobbin 3 shown in FIG. 18, each of the positioning portion 3c includes three or more projections 3ca. The projections 3ca that are displaced by 90 degrees in phase from the projections 3ca that are in contact with the flange portion 2b (FIG. 20) of the core 2, that is, the projections 3ca that are located outside the core 2 in a state where the inductor 1 is assembled as shown in FIG. 19, do not have to be provided. Each positioning portion 3c may be in the form of a projection extending in an annular shape (not shown). In this case, the inner diameter of the projection may be smaller than the inner diameter of the bobbin 3, or may be equal to the inner diameter of the bobbin 3.

In the inductor 1 as well, using the bobbin 3 provided with the positioning portions 3c provides an adequate creepage distance of the bobbin 3 between the coil 4 and the core 2.

### Seventh Embodiment

An inductor according to a seventh embodiment includes a core 2 that is different from those of the inductors according to the preceding embodiments. Components that are the same as those in the preceding embodiments are designated by the same reference numerals, and the description thereof is omitted.

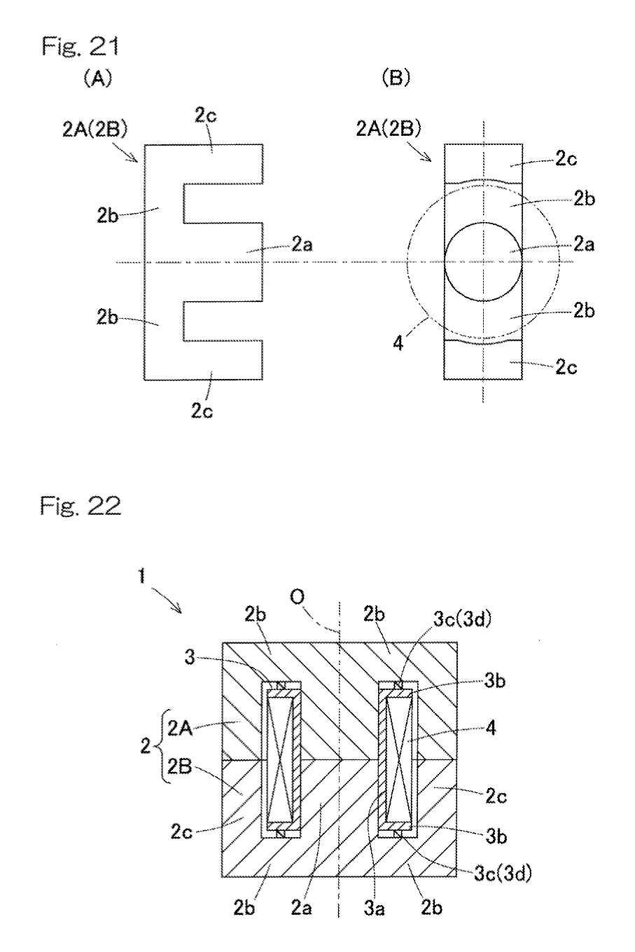

A diagram (A) in FIG. 21 is a front view of an ER type core, a diagram (B) in FIG. 21 is a side view of the ER type core, and FIG. 22 is a sectional view of an inductor 1 in which a core 2 is formed of two core segments 2A and 2B each composed of the ER type core. The bobbin 3 has substantially the same shape as the bobbin 3 of the first embodiment (FIG. 3) or the bobbin 3 of the second embodiment (FIG. 7). In the inductor 1 as well, using the bobbin 3 provided with the positioning portions 3c (3d) as described above provides an adequate creepage distance of the bobbin 3 between the coil 4 and the core 2. The bobbin 3 of the third embodiment (FIG. 11) may be used.

### Eighth Embodiment

An inductor according to an eighth embodiment includes a core 2 that is different from those of the inductors according to the preceding embodiments. Components that are the same as those in the preceding embodiments are designated by the same reference numerals, and the description thereof is omitted.

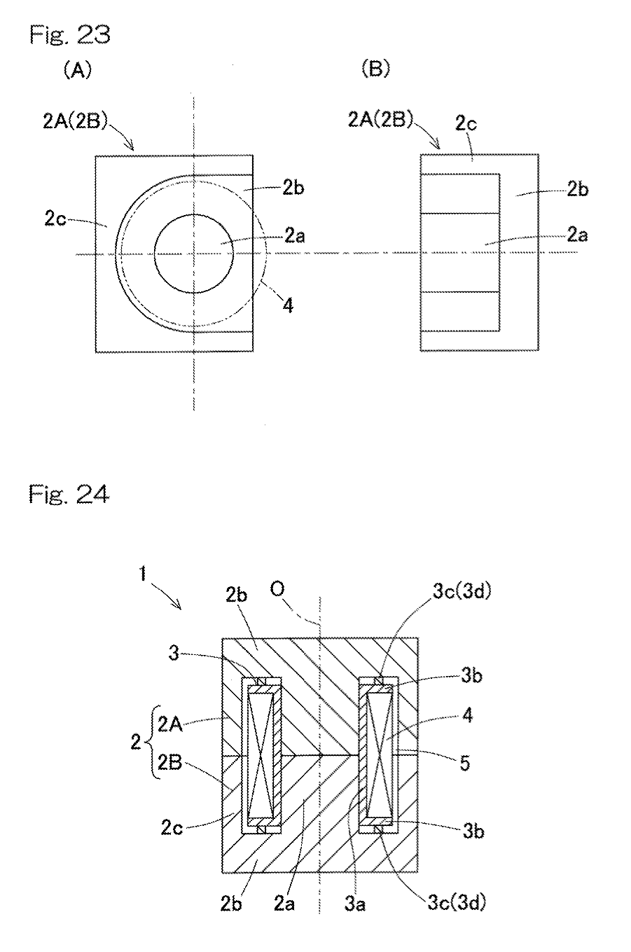

A diagram (A) in FIG. 23 is a plan view of an EP type core, a diagram (B) in FIG. 23 is a side view of the EP type core, and FIG. 24 is a sectional view of an inductor 1 in which a core 2 is formed of two core segments 2A and 2B each composed of the EP type core. The bobbin 3 has substantially the same shape as the bobbin 3 of the first embodiment (FIG. 3) or the bobbin 3 of the second embodiment (FIG. 7). In the inductor 1 as well, using the bobbin 3 provided with the positioning portions 3c (3d) as described above provides an adequate creepage distance of the bobbin 3 between the coil 4 and the core 2.

The bobbin 3 of the third embodiment (FIG. 11) may be used.

### Ninth Embodiment

An inductor according to a ninth embodiment includes a core flange division type core 20. Components that are the same as those in the preceding embodiments are designated by the same reference numerals, and the description thereof is omitted.

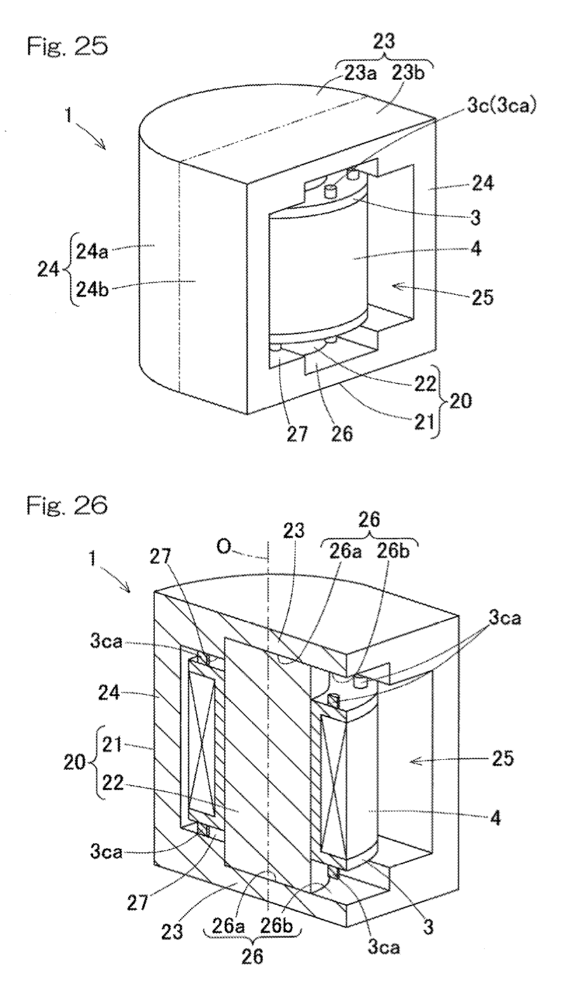

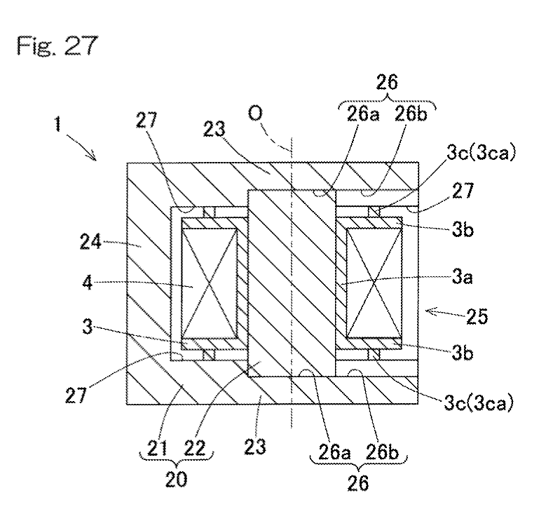

FIG. 25 is a perspective view of the inductor which includes the core collar division type core, FIG. 26 is a perspective view of the inductor divided vertically along a plane passing through the central axis O of the core, and FIG. 27 is a sectional view of the inductor. The core 20 in the inductor 1 includes a cup-shaped peripheral core 21 and a central core 22. The peripheral core 21 and the central core 22 may be magnetic bodies formed from magnetic materials that are the same as each other, or may be magnetic bodies formed from magnetic materials different from each other. The respective magnetic materials for the peripheral core 21 and the central core 22 can be selected in accordance with required characteristics of the inductor 1.

The peripheral core 21 has a cup shape including: two collar portions (core flange portions) 23, 23 that are disposed at both respective ends in the axial direction; and a side wall portion 24 that connects the radially outer ends of the two respective collar portions 23, 23. Each collar portion 23 has a planar shape including a semicircular portion 23a and a rectangular portion 23b extending for a length equal to the width of the chord of the semicircular portion 23a. The side wall portion 24 includes a circular-arc-shaped side wall portion 24a that extends along the radially outer ends of the respective semicircular portions 23a of collar portions 23; and a pair of flat-plate-shaped portions 24b, 24b that extend from both respective sides of the circular-arc-shaped side wall portion 24a. Each flat-plate-shaped portion 24b extends along opposite sides, each at one side of the rectangular portions 23b. An opening 25 is formed between the distal edges of the flat-plate-shaped portions 24b, 24b.

A groove 26 is formed on the axially inner surface of each collar portion 23. The groove 26 includes a center groove portion 26a and a central core introduction groove portion 26b. A portion other than the groove 26, that is, an outer peripheral portion 27 adjacent to the side wall portion 24, projects more inwardly in the axial direction than the portion where the groove 26 is formed.

The central core 22 has a circular column shape. The central core 22 has the axial length between both ends thereof, which are in contact with the respective center groove portions 26a, 26a of the two collar portions 23, 23 in a state where the central core 22 is assembled to the peripheral core 21. The central core 22 corresponds to the middle portion 2a of the axial division type core 2, and the coil 4 is wound on the outer periphery of the central core 22 via the bobbin 3. In the example of FIG. 25 to FIG. 27, the bobbin 3 shown in FIG. 3 is used.

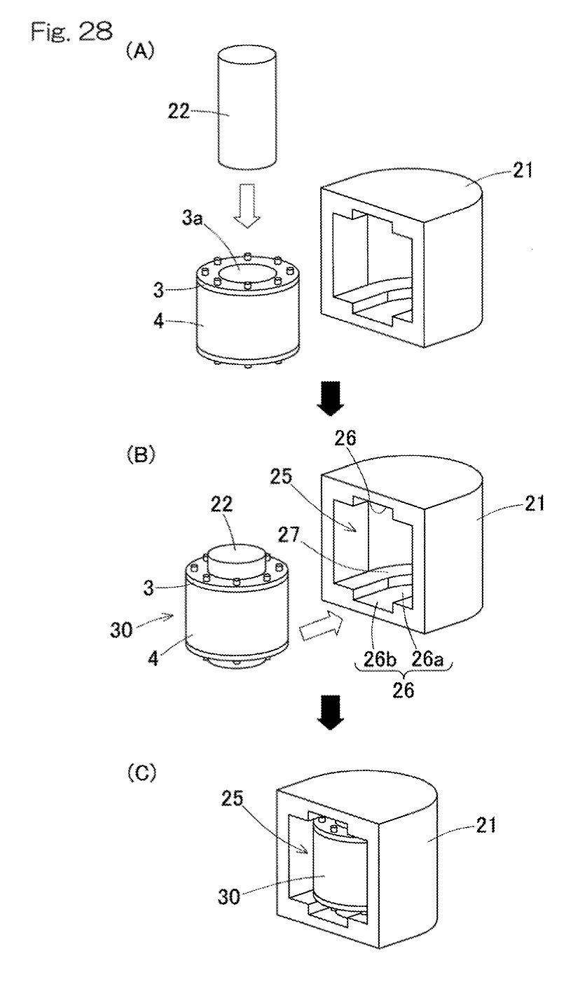

FIG. 28 is diagrams illustrating an assembling procedure for the inductor 1.

As shown in a diagram (A) in FIG. 28, the coil 4 is wound on the hollow cylindrical portion 3a of the bobbin 3 in advance, and the central core 22 is inserted into the inner periphery of the hollow cylindrical portion 3a of the bobbin 3 having the coil 4 wound thereon, thereby assembling a coil unit 30 (see a diagram (B) in FIG. 28). Alternatively, the central core 22 may be inserted into the inner periphery of the hollow cylindrical portion 3a of the bobbin 3, and then the coil 4 may be wound on the hollow cylindrical portion 3a of the bobbin 3.

Next, as shown in a diagram (B) in FIG. 28, the coil unit 30 is assembled into the peripheral core 21. In particular, the coil unit 30 is inserted through the opening 25 of the peripheral core 21 such that both ends of the central core 22 pass through the central core introduction groove portions 26b. The central core 22 is then pressed until both ends of the central core 22 reach the positions of the center groove portions 26a, and thus, the inductor 1 is assembled as shown in a diagram (C) in FIG. 28. In the assembled state in the diagram (C) in FIG. 28, the opening 25 of the peripheral core 21 may be closed by a cover (not shown).

In the assembled inductor 1, as shown in FIG. 27, both ends of the central core 22 are in contact with the two respective collar portions 23, 23 of the peripheral core 21, and the core 20, which is a magnetic body, is formed by the peripheral core 21 and the central core 22. Similar to the axial division type core 2 (FIG. 2), the core 20 has the central core 22, the two collar portions 23, 23 that spread radially outward from both ends of the central core 22 in the axial direction, respectively, and the side wall portion 24 that connects the radially outer ends of the two collar portions 23, 23. The annular coil 4 is wound on the central core 22 via the bobbin 3.

In the inductor 1 as well, similar to the inductor 1 including the axial division type core 2, since the distal ends of the positioning portions 3c of the bobbin 3 are brought into contact with the outer peripheral portions 27 of the collar portions 23 of the core 20, the bobbin 3 is positioned in the axial direction, so that the distance between the core 20 and the coil 4 is kept constant. In this way, electric insulation between the core 20 and the coil 4 is ensured, and magnetic characteristics such as an inductance value are stabilized. Similar to the inductor 1 including the axial division type core 2, an adequate creepage distance of the bobbin 3 between the coil 4 and the core 20 can be provided.

### Tenth Embodiment

An inductor according to a tenth embodiment includes a core collar division type core 20. Components that are the same as those in the preceding embodiments are designated by the same reference numerals, and the description thereof is omitted.

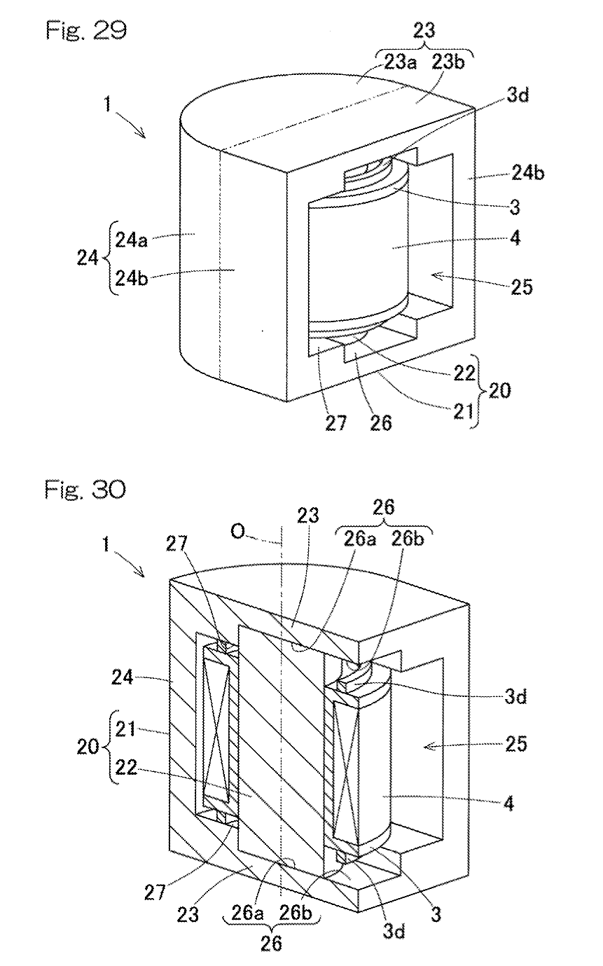

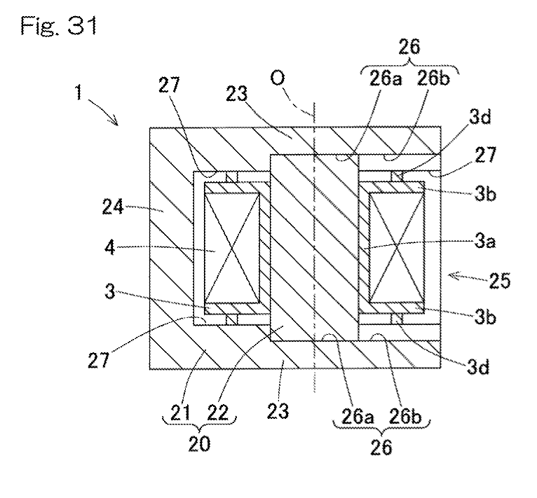

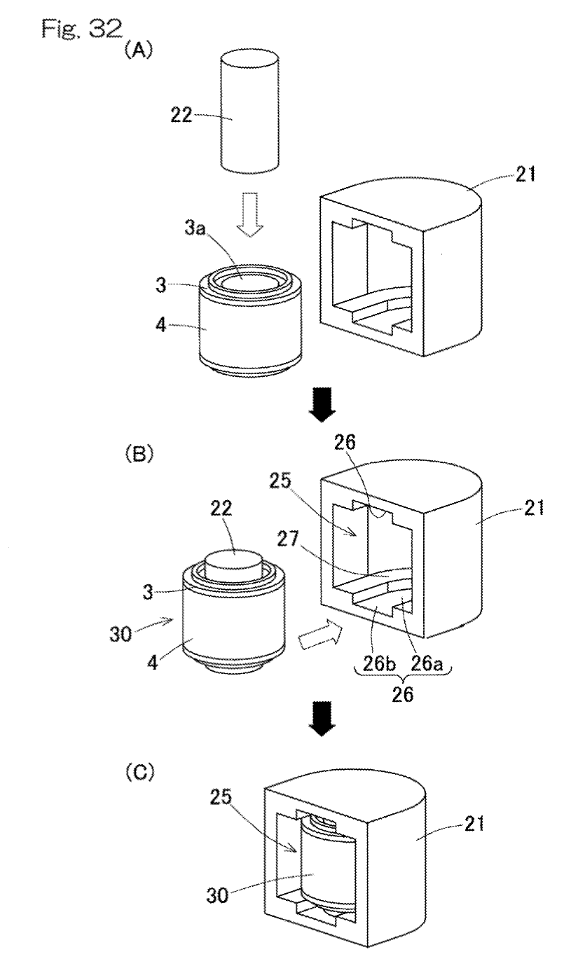

FIG. 29 is a perspective view of the inductor according to the tenth embodiment, which includes the core collar division type core, FIG. 30 is a perspective view of the inductor divided vertically along a plane passing through the central axis O of the core, and FIG. 31 is a sectional view of the inductor. Whereas the bobbin 3 shown in FIG. 3 is used in the inductor 1 shown in FIG. 25 to FIG. 27, the bobbin 3 shown in FIG. 7 is used in this inductor 1. The other configuration is the same as that of the inductor 1 shown in FIG. 25 to FIG. 27. An assembling procedure is also the same as that for the inductor 1 shown in FIG. 25 to FIG. 27 (see FIG. 32).

Each positioning portion 3d having a ring shape as described above enables the strength of each flange portion 3b to be increased. As such, the thickness of each flange portion 3b can be reduced.

### Eleventh Embodiment

An inductor according to an eleventh embodiment includes a core collar division type core 20. Components that are the same as those in the preceding embodiments are designated by the same reference numerals, and the description thereof is omitted.

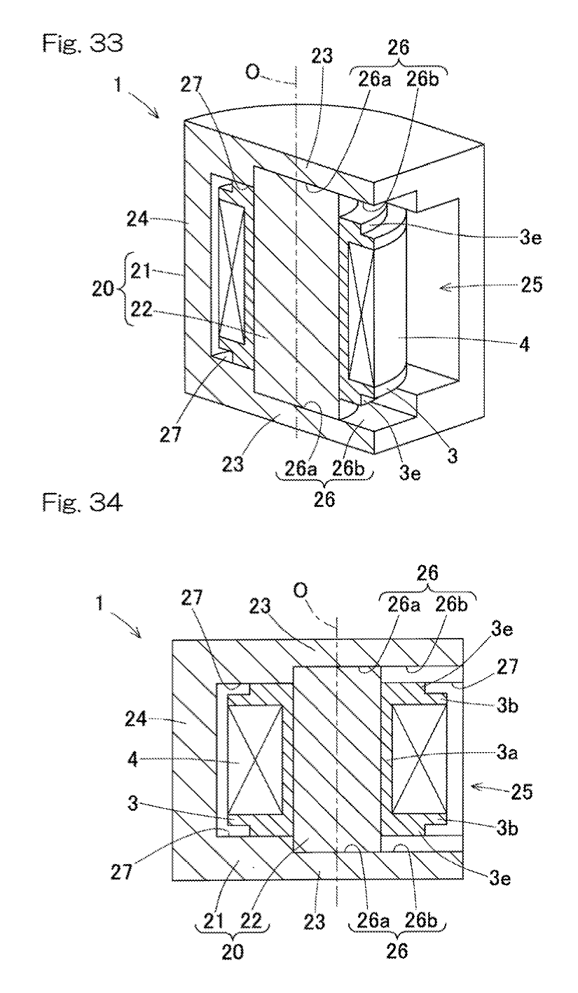

FIG. 33 is a perspective view of the inductor according to the eleventh embodiment, which includes the core collar division type core, wherein the inductor is divided vertically along a plane passing through the central axis O of the core, and FIG. 34 is a sectional view of the inductor. The inductor 1 includes the bobbin 3 shown in FIG. 11. The other configuration is the same as those of the inductor 1 shown in FIG. 25 to FIG. 27 and the inductor 1 shown in FIG. 29 to FIG. 31. An assembling procedure is also the same as that for each of the inductors 1 including the central core division type core (not shown).

Positioning portions 3e each having the inner diameter that is equal to the inner diameter of the bobbin 3 as described above can further increase the strength of the flange portions 3b.

Although the present invention has been described above in connection with the preferred embodiments thereof with reference to the accompanying drawings, numerous additions, changes, or deletions can be made without departing from the gist of the present invention. Accordingly, such additions, changes, or deletions are to be construed as included in the scope of the present invention.

### REFERENCE NUMERALS

1 . . . inductor
2 . . . core
2A, 2B . . . core segment
2a . . . middle portion
2b . . . collar portion (core flange portion)
2c . . . side wall portion
3 . . . bobbin
3b . . . flange portion (bobbin flange portion)
3c . . . positioning portion
3d . . . positioning portion
3e . . . positioning portion
4 . . . coil
20 . . . core
23 . . . collar portion (core flange portion)
24 . . . side wall portion
O . . . central axis

What is claimed is:

1. An inductor comprising:
a core including
a middle portion extending in an axial direction,
two core flange portions spreading radially outward from both respective ends of the middle portion in the axial direction, and
a side wall portion connecting radially outer ends of the two respective core flange portions;
a bobbin including a cylindrical portion extending in the axial direction, the cylindrical portion being fitted to an outer periphery of the middle portion; and
an annular coil wound on the middle portion of the core via the cylindrical portion of the bobbin, wherein
the bobbin further includes
bobbin flange portions extending from both respective ends of the cylindrical portion, each bobbin flange portion separating the corresponding core flange portion of the core from the coil, and
a positioning portion located at a radially inner side with respect to a radially outer end of the bobbin flange portion, the positioning portion being provided on a surface, of at least one of the bobbin flange portions, that faces the corresponding core flange portion, the positioning portion projecting toward and abutting at a distal end thereof the corresponding core flange portion.

2. The inductor as claimed in claim 1, wherein the positioning portion is provided on each of surfaces, of both of the bobbin flange portions, each of the surfaces facing the corresponding core flange portion.

3. The inductor as claimed in claim 1, wherein the core includes two pot-shaped core segments adjacent to each other in the axial direction.

4. The inductor as claimed in claim 1, wherein the core includes
a peripheral core including the side wall portion and the two core flange portions, a part of the side wall portion in a circumferential direction being open so that the peripheral core has a cup shape, and
a central core that is assembled into the peripheral core so that both ends of the central core are in contact with respective inner surfaces of the two core flange portions in the axial direction, the central core corresponding to the middle portion.

5. The inductor as claimed in claim 4, wherein the peripheral core and the central core are formed from magnetic materials that are the same as each other.

6. The inductor as claimed in claim 4, wherein the peripheral core and the central core are formed from magnetic materials that are different from each other.

7. The inductor as claimed in claim 1, wherein the positioning portion includes three or more projections located so as to be spaced apart from each other in a circumferential direction.

8. The inductor as claimed in claim 6, wherein the three or more projections are located, on a circumference of a circle concentric with the bobbin, so as to be spaced apart from each other.

9. The inductor as claimed in claim 7, wherein intervals between any adjacent projections of the three or more projections are equal to each other.

10. The inductor as claimed in claim 1, wherein the positioning portion has a ring shape concentric with the bobbin.
